(19) United States
(12) Patent Application Publication
(10) Pub. No.: US 2006/0042455 A1
(43) Pub. Date: Mar. 2, 2006

(54) Piezoelectric transducer for stringed musical instruments

(76) Inventor: Leslie M. Schatten, Kitchener (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 11/214,011

(22) Filed: Aug. 30, 2005

Related U.S. Application Data
(60) Provisional application No. 60/605,523, filed on Aug. 31, 2004.

(51) Int. Cl. G10H 3/18

(52) U.S. Cl. 84/731

(57) ABSTRACT

The invention is directed at a piezoelectric transducer for a stringed musical instrument which reproduces the real acoustic tonal qualities and resonances of an acoustic instrument. Also, due to its design, the transducer provides improved feedback control and feedback rejection over prior art devices. The transducer comprising a base unit; a piezoelectric unit, including a piezoelectric element housed within a shielding enclosure; and a multi-conductor cable connected to said piezoelectric element for transmitting signals produced by said piezoelectric element.

### CROSS REFERENCE TO RELATED APPLICATIONS

This application claims the benefit of U.S. Provisional Application No. 60/605,523, filed Aug. 31, 2004, which is incorporated herein by reference.

### BACKGROUND OF THE INVENTION

1. Field of the Invention

This invention relates to musical instrument transducers and specifically to a piezoelectric transducer for stringed musical instruments.

2. Description of the Prior Art

At present, piezoelectric transducers for guitars can be broken down into two prominent types:

1) Transducers that are located in the bridge saddle slot of the guitar with the saddle of the instrument situated on top of the transducer, and a subgroup of that design where the transducer is integrated within the saddle itself. These transducers receive vibration from string actuation acting almost entirely upon the bridge saddle and do not pick up the actual tonal qualities, vibrations or resonances, or the acoustic instrument body structure. The transducers in this group are also generally complex to manufacture, can be complicated to install in an instrument, and can be fragile in structure. Furthermore, the sound quality produced by these transducers does not accurately reproduce the acoustic nature of the instrument that the transducer is installed within. Transducers of these types are described in U.S. Pat. No. 4,491,051 to Barcus, U.S. Pat. No. 4,727,634 to Fishman, U.S. Pat. No. 4,774,867 to Fishman and U.S. Pat. No. 5,155,285 to Fishman.

2) Transducers that are attached to the soundboard or bridge plate of the musical instrument. Transducers in this second group are generally better in being able to more accurately reproduce the acoustic tonal qualities of the instrument but are usually not able to provide quality feedback rejection. These soundboard transducers that seek to overcome the low feedback threshold are often very complex, difficult and costly to manufacture, and difficult to install into an instrument or to retrofit into an existing instrument. A transducer to this type is described in U.S. Pat. No. 6,605,771 to Baggs.

### SUMMARY OF THE INVENTION

It is an aspect of the present invention to provide an improved piezoelectric transducer, preferably for use with a stringed musical instrument such as a steel string or classical guitar. Another aspect of the present invention is to provide an improved transducer which provides the conversion of string vibrations into electrical signals that substantially exactly correspond with the character of such string vibrations.

A further aspect of the present invention is to provide an improved musical instrument transducer which is simple in construction and may be easily and inexpensively fabricated.

Another aspect of the present invention is to provide an improved musical instrument transducer that is readily useable for retrofitting to existing stringed instruments without requiring major modification thereto.

A further aspect of the present invention is to provide an improved musical instrument transducer that does not interfere with the normal sound characteristics, adjustments or playing action of the instrument during instrument string actuation when it is installed.

In another aspect of the invention, a means for more accurate sound reproduction is provided. Although the present invention is adapted for use with a steel string guitar or nylon string guitar, it may be used in association with other stringed musical instruments such as a banjo, mandolin, arch-top guitar, violin, bass or other musical instrument having a vibrating and/or moving soundboard or other resonating surface.

In yet a further aspect, the invention provides a transducer that attaches or adheres to the bridge plate or soundboard of an instrument generally in the area directly under the saddle. Due to its design, the transducer preferably reproduces the real acoustic tonal qualities and resonances of an acoustic instrument. Also, due to its design, the transducer provides improved feedback control and feedback rejection over prior art devices.

In another aspect, there is provided a piezoelectric transducer comprising a base unit; a piezoelectric unit, including a piezoelectric element housed within a shielding enclosure; and a multi-conductor cable connected to said piezoelectric element for transmitting signals produced by said piezoelectric element.

In another aspect, there is provided A piezoelectric transducer for a stringed musical instrument, securable to a resonating surface of said instrument, comprising a piezoelectric unit raised above said resonating surface by a supporting lower base unit, said piezoelectric unit having a piezoelectric element surrounded by and attached on one surface to a suitable RF shielding medium.

Further details of the invention will be described or will become apparent in the course of the following detailed description.

### BRIEF DESCRIPTION OF THE DRAWINGS

The invention will now be described with reference to the accompanying drawings of preferred and alternative embodiment(s), by way of example only. In the drawings:

FIG. 1 is a front view of a first embodiment of the invention.

FIG. 2 is a cut-away view taken along line 2-2 of FIG. 1.

FIG. 3 is a perspective view of an underside of a stringed instrument top having a transducer mounted.

FIG. 4 is a broken-away front view of the transducer of FIG. 1.

FIG. 5 is a front view of a second embodiment of the invention mounted to a stringed instrument.

FIG. 6 is a cut-away view of a piezoelectric unit.

FIG. 7 is a front view of yet another embodiment of the invention mounted to a stringed instrument.

### DETAILED DESCRIPTION OF THE INVENTION

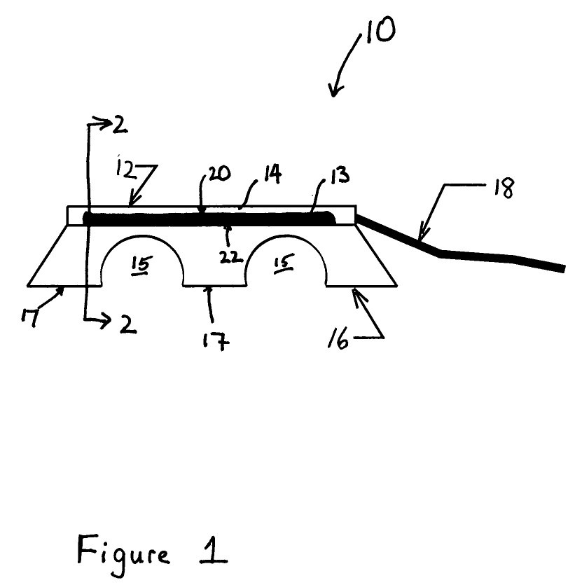

The invention is directed at a piezoelectric transducer for stringed musical instruments. Turning to FIGS. 1 to 4, a first embodiment of a piezoelectric transducer in accordance with the invention is shown.

Turning to FIG. 1, a front view of the transducer is shown. The transducer 10 comprises a piezoelectric unit 12 (comprising a piezoelectric element 13, preferably a piezoelectric crystal, in an enclosure 14). The enclosure 14 provides radio frequency (RF) shielding and is preferably manufactured out of brass but other suitable materials such aluminum or a conductive plastic may be used. The piezoelectric unit 12 rests atop a base unit 16 which comprises, in this embodiment, three (3) legs 17 which contact the stringed instrument, as will be described below. The base unit 16 provides support to the piezoelectric unit 12 and the design (based on the location of cutouts 15) of the base unit 16, (having a pair of arches and the three legs) allow for proper vibration transmission, structural integrity, and clearances necessary to avoid contact with areas of the vibrating top surface of the instrument or its supporting structures and bracing.

A shielded multi-conductor cable 18 connects electrically to both top 20 and bottom 22 surfaces of the piezoelectric element 13 within the upper piezoelectric unit 12.

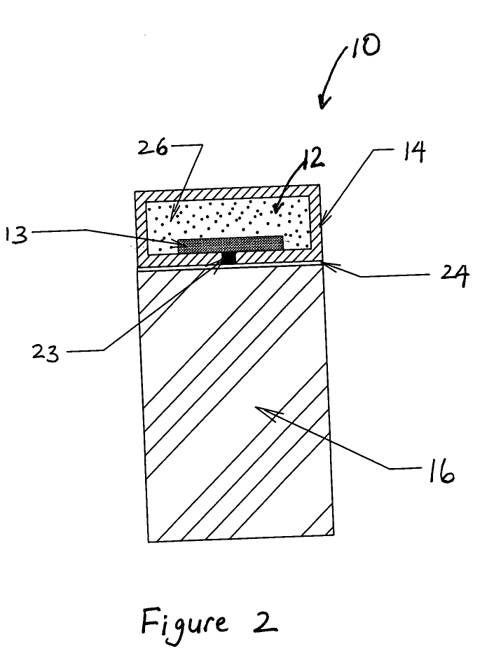

FIG. 2 shows a cut-away view taken along line 2-2 of FIG. 1. In this view, the details for the piezoelectric unit 12 and the base unit 16 are more clearly shown. The piezoelectric element 13 is preferably attached to an inner surface of the enclosure 14 via a soldering process 23, however, it will be understood that other methods of adhesion such as conductive glue are also contemplated. In the preferred embodiment, the piezoelectric unit 12 is attached to the base unit 16 via a double-sided adhesive 24 (shown in exaggerated thickness for clarity). The enclosure 14 is also preferably filled with an epoxy 26 thus encapsulating the piezoelectric element 13 to support the piezoelectric element 13 so that the element is firmly located in the enclosure 14. The epoxy 26 is selected to have necessary sound transmission properties as understood by one skilled in the art.

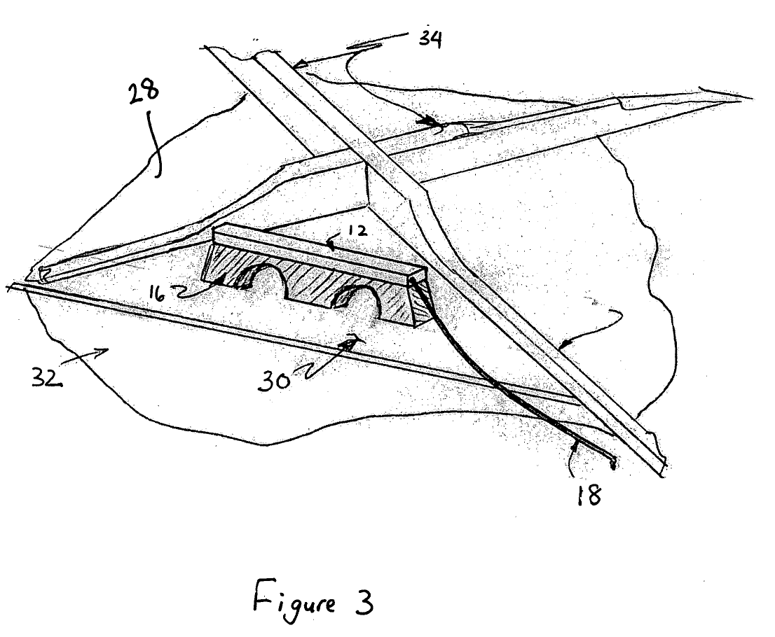

FIG. 3 is a perspective view of the transducer installed on a stringed instrument 28, such as a guitar. In this figure, the transducer 10 is installed on an underside of the guitar. The transducer 10 is preferably located on a bridge plate 30 (but may be located on any other vibrating surface) and attached to the bridge plate 30 via a pressure sensitive adhesive tape, a mastic putty, an epoxy, pressure sensitive tapes or any other adhesive which provides the necessary vibration transmission qualities. The bridge plate 30 is a slightly raised surface providing extra strength in the area under a guitar bridge for the top 32 of the instrument 28. Bracing 34 are also located in the underside of the guitar to provide further structural support. It will be understood that the type of material with which the transducer is attached to the vibrating surface of the instrument may vary in order to lessen or increase the amount of vibration being fed through the base unit 16.

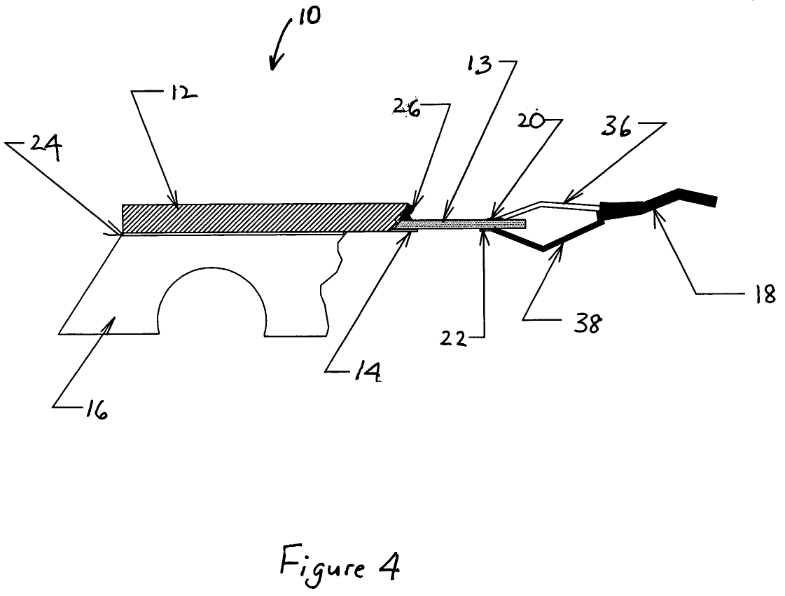

FIG. 4 shows a view of the first embodiment of the invention which further illustrates the contact between the piezoelectric element 13 and the cable 18. The multi-conductor cable 18 comprises a first, insulated, lead wire 36 which is preferably soldered to the top surface 20 of the piezoelectric element 13 and a second lead wire 38, which is preferably soldered to the bottom surface 22 of the piezoelectric element 13. Both the first and second lead wires 36 and 38, respectively, are contained within the shielded cable 18. The other ends of the lead wires 36 and 38 (or cable 18) are preferably connected to a means for amplifying the vibrations experienced by the transducer. Examples of means for amplifying include an amplifier or a public address system.

In use, as a musician, plucks, strums or bows the strings of the musical instrument, the movement of the strings imparts a vibration through the bridge or other string supporting structure of the instrument to the soundboard and the transducer. The movement of the strings causes the bridge (or whatever vibrating support structure the transducer is mounted to) to vibrate which is then translated to the transducer. The transducer then generates a voltage as a result of the vibrations received from the interaction between the transducer and the bridge (or whatever vibrating support structure the transducer is mounted to), the vibration of the soundboard and/or the vibrations of the musical instrument bracing.

The vibration of the piezoelectric element 13 in the transducer 10 (which is somewhat regulated by the vibration transmission qualities of the adhesive attaching the transducer to the musical instrument 28) generates a voltage in response to the mechanical vibrations. This voltage is then transmitted through the lead wires 36 and 38 to the amplifying means in order to amplify the sound produced by the musical instrument 28. Due to the design of the transducer, the sounds which are produced by the transudcer are of better quality than prior art transudcers.

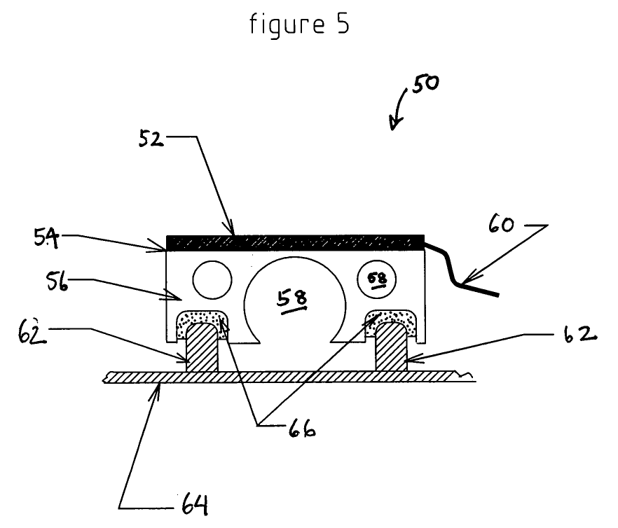

Turning to FIGS. 5, a second embodiment of a piezoelectric transducer is shown. FIG. 5 is a front view of the transducer mounted to a musical instrument. The transducer 50 comprises a piezoelectric unit 52 (comprising a piezoelectric element 53 in an enclosure 54) and a base unit 56 for supporting the piezoelectric unit 52. The base unit 56 includes a number of cutouts 58 which are important to the vibration transmission quality of the transducer 50. As with the previous embodiment, a conducting cable 60 is connected to the piezoelectric element 52 within the enclosure 54. The shape and position of the cutouts 58 are selected/designed so that the base unit 56 does not contact the surface of the musical instrument.

The base unit 56 is mounted to bracing 62 of a musical instrument 64, in t he present embodiment via a pair of cutouts 58. The mounting is assisted by a mounting material 66 such as mastic putty.

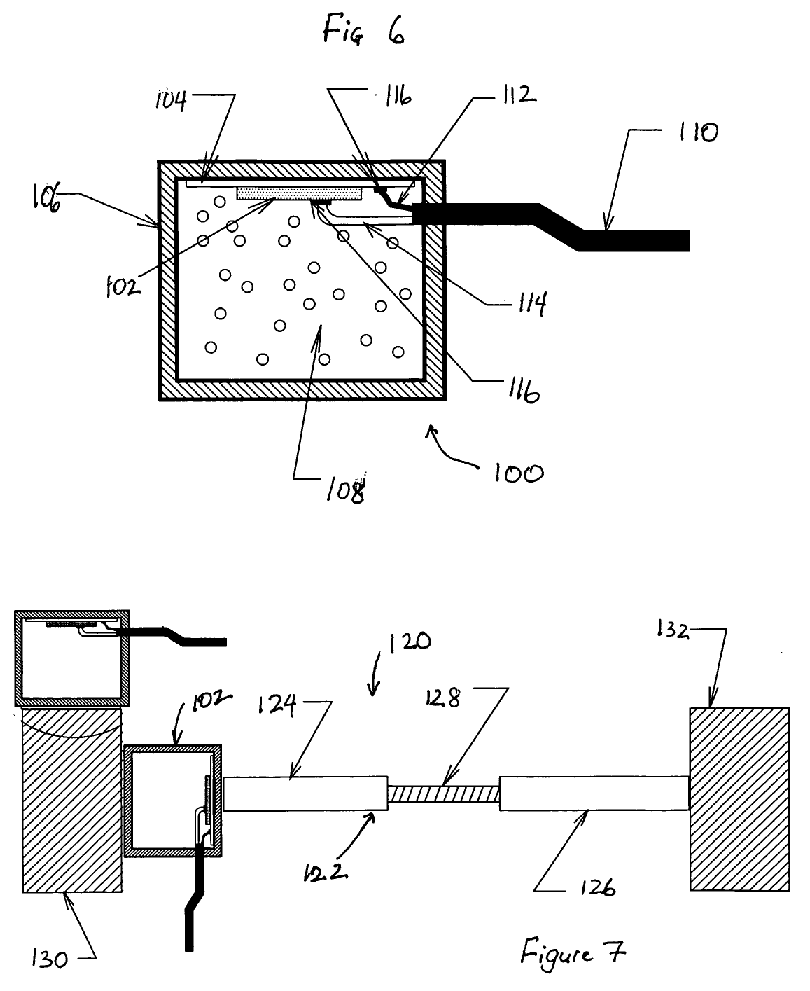

Turning to FIG. 6, a schematic view of a second embodiment of a piezoelectric unit is shown. In this embodiment, the piezoelectric unit 100 comprises a piezoelectric element 102 mounted to a brass strip 104 which is in physical contact with an inner surface of an enclosure 106. The piezoelectric element 102 is preferably surrounded by a potting medium or epoxy 108 within the enclosure 106.

In the present embodiment, a conducting cable 110, comprising a pair of lead wires 112 and 114, is connected to the brass strip 104 and the piezoelectric element 102 via the lead wires 112 and 114, respectively to transmit voltages produced by the piezoelectric element 102 when the musical instrument is being used. As shown, the lead wires 112 and 114 are preferably soldered 116 to the brass strip 104 and the piezoelectric element 102.

FIG. 7 displays another method of mounting a transducer on a musical instrument. In FIG. 7, the transducer 120 comprises a piezoelectric unit 102 (as shown in FIG. 6) attached to a base unit 122 having a first part 124and a second part 126 connected via an adjustable rod 128 (or spring). In this embodiment, the piezoelectric unit 102 is placed up against a vibrating surface 130 of a musical instrument while the second part 126 of the base unit 122 is placed against a second vibrating surface 132 of the musical instrument. An example of the first and second vibrating surfaces 130 and 132 is the two legs of a double bass bridge over an opening of the double bass. In this embodiment, more physical energy is imparted to the transducer which, in turn, produces a higher voltage for amplification. Alternatively, a second piezoelectric unit 134 may be mounted directly to one of the vibrating surfaces 130.

Although described as a piezoelectric crystal, the piezoelectric element may also be a piezo-polymer film, or sensor material, or any other material that may provide the electrical output and signal qualities necessary for differing uses and applications of the transducer.

Although the attachment of the piezoelectric element to the enclosure and the two lead wires is preferably performed via a soldering process, it will be understood that other means of attaching the piezoelectric element to these parts such as a conducting adhesive are contemplated. A conducting adhesive is simply an adhesive which not only adheres two surfaces but allows for the transmission of signals between the two surfaces, namely the piezoelectric element and the lead wires or enclosure.

In an alternative embodiment, the lead wires may be connected to a preamplifier prior to being connected to the means for amplifying the signals.

Although the base unit 16 is preferably made of wood, in other embodiments, the base unit 16 may be made of any medium such as plastic, aluminum, or fiber as necessary to provide proper vibration transmission properties and support for the piezoelectric unit 12.

As described above, the base unit is preferably attached to the piezoelectric unit 12 via a double-sided adhesive. However, the base unit may also be attached to the piezoelectric unit 12 with cyanoacrylate adhesive, epoxy or any other form of adhesive, adhesive sheet or means of mechanical fastening as may be necessary which provides vibration transmissions from the base unit 16 to the piezoelectric unit 12.

Although shown in FIG. 1 as having three legs sandwiching a pair of arches, the design of the base unit may be altered so that the transducer may be used with all different shaped stringed instruments. The design (location of cutouts) of the base unit is selected so that the integrity of the sound provided by the transducer is not compromised.

Although described as two separate parts, the piezoelectric unit 12 and the base unit 16 may be a single unit combining the base and piezoelectric unit into one integrated structure containing all elements of the invention conferring all required vibration transmission properties and RF shielding. Furthermore, although the piezoelectric unit and the base unit are shown to be of similar length/width, it will be understood that the sizes of the piezoelectric unit and the base unit need not be the same.

Further, other embodiments may have multiple or differing base units and multiple piezoelectric units with the base units set in various arrays such as a “T” shape or any other shape. In the multiple piezoelectric unit embodiments, the units may be mounted to separate transverse bracing of the musical instrument in order to sample the vibrations from multiple locations when the instrument is being played. It will also be understood that multiple single piezoelectric unit transducers may be mounted to the same bracing while not affecting the sound transmission quality.

The present invention comprises a piezoelectric unit that is raised above the mounting surface by a supporting lower base unit. The preferred embodiment of the piezoelectric unit has a piezoelectric element that is surrounded by and attached on one surface to an RF shielding medium of brass. In other embodiments the RF shielding medium may be of conductive plastic or other such materials that may provide suitable sound transmission characteristics and shielding properties to the contained piezoelectric element. Furthermore, in other embodiments, the transducer may not include the RF shielding medium, or enclosure.

An advantage of the invention is that it is much less complex, more economical to produce and is easily retrofitted to existing instruments.

Another advantage of the invention is the design of the base unit (such as the arches) which allows the base unit to move freely and to act in a spring-like fashion than a solid base unit without cutouts. A further advantage is that the mounting of the transducer to the bridge plate is seen as a “soft” mounting which isolates the transducer from the vibrating surface in a controlled manner and allows the transducer to move relatively freely in relation to the instrument.

Another advantage of the invention is that the cutouts of the base unit impart more focused vibrational energy to the piezoelectric unit than would a solid base unit (although a solid base may be contemplated). Other embodiments of the invention may vary the shape of the cut outs in the base unit to allow for the increase or decrease in vibration transmission as might be required. Still other embodiments of the invention may vary the amount of spring action imparted by the base unit to the piezoelectric unit depending upon the requirements of the application.

Another advantage is that the adhesive used to attach the base unit to the piezoelectric unit contributes to the vibration control and transmission properties from the lower base unit to the piezoelectric unit.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A piezoelectric transducer for a stringed musical instrument comprising:
a base unit for mounting to said stringed musical instrument;
a piezoelectric unit, connected to said base unit, including a piezoelectric element housed within a shielding enclosure; and
a multi-conductor cable connected to said piezoelectric element for transmitting signals produced by said piezoelectric element.

2. The piezoelectric transducer of claim 1 wherein said base unit comprises at least one cutout.

3. The piezoelectric transducer of claim 1 wherein said piezoelectric unit is mounted to said base unit.

4. The piezoelectric transducer of claim 1 wherein said cable comprises:
a first lead wire for attachment to a first surface of said piezoelectric element; and
a second lead wire for attachment to a second surface of said piezoelectric element.

5. The piezoelectric transducer of claim 1 wherein said cable comprises:
a first lead wire for attachment to a first surface of said piezoelectric element; and
a second lead wire for attachment to said enclosure.

6. The piezoelectric transducer of claim 1 wherein said piezoelectric unit is mounted to said base unit via an adhesive selected from the group consisting of double sided sheet adhesive, cyanoacrylate and epoxy.

7. The piezoelectric transducer of claim 1 wherein said shielding enclosure is made of a material selected from the group consisting of brass, aluminium and conductive plastic.

8. The piezoelectric transducer of claim 1 wherein said piezoelectric element is connected to said shielding enclosure via a conductive glue or soldering.

9. The piezoelectric transducer of claim 1 wherein said base unit is manufactured from wood.

10. The piezoelectric transducer of claim 2 wherein said set of cutouts are a pair of arches.

11. The piezoelectric transducer of claim 10 wherein said cutouts further comprise a pair of holes.

12. The piezoelectric transducer of claim 1 wherein said piezoelectric unit further comprises a filer material within said enclosure.

13. The piezoelectric transducer of claim 1 wherein said piezoelectric element is one of a piezoelectric crystal, a piezo-polymer film or a sensor material.

14. The piezoelectric transducer of claim 1 wherein said base unit comprises:
a first part, connected to said piezoelectric unit;
a second part; and
an adjustable medium connecting said first part to said second part;
wherein said second part is mounted to said musical instrument.

15. The piezoelectric transducer of claim 14 wherein said piezoelectric unit is mounted to said musical instrument.

16. A piezoelectric transducer for a stringed musical instrument, securable to a resonating surface of said instrument, comprising:
a piezoelectric unit raised above said resonating surface by a supporting lower base unit, said piezoelectric unit having a piezoelectric element surrounded by and attached on one surface to a suitable RF shielding medium.

17. A transducer as in claim 16, wherein said piezoelectric element is electrically connected on one surface to the shielding medium, and a lead wire is connected to the shielding medium and to the opposite surface of the piezoelectric material.
